(19) United States
(12) Patent Application Publication
(10) Pub. No.: US 2026/0134363 A1
(43) Pub. Date: May 14, 2026

(54) PROGRESS MANAGEMENT DEVICE, PROGRESS MANAGEMENT METHOD, AND NON-TRANSITORY COMPUTER READABLE MEDIUM

(71) Applicant: Mitsubishi Electric Corporation, Tokyo (JP)

(72) Inventors: Gosuke MINAMI, Tokyo (JP); Kazuki WATANABE, Tokyo (JP)

(73) Assignee: Mitsubishi Electric Corporation, Tokyo (JP)

(21) Appl. No.: 19/389,286

(22) Filed: Nov. 14, 2025

Related U.S. Application Data
(63) Continuation of application No. PCT/JP2023/022812, filed on Jun. 20, 2023.

(51) Int. Cl. G06Q 10/0631

(52) U.S. Cl. CPC G06Q 10/06312

(57) ABSTRACT

A progress management device (100) to manage progress of system development based on progress that corresponds to each task in the system development and is input by a person in charge of each task includes a delay risk calculation unit (140). The delay risk calculation unit (140) determines whether there is a risk of occurrence of a delay in an ongoing task, which is a task in progress in the system development, based on the number of times a target person in charge, who is a person in charge of the ongoing task, has input progress corresponding to the ongoing task.

### CROSS REFERENCE TO RELATED APPLICATION

This application is a Continuation of PCT International Application No. PCT/JP 2023/022812, filed on Jun. 20, 2023, which is hereby expressly incorporated by reference into the present application.

### TECHNICAL FIELD

The present disclosure relates to a progress management device, a progress management method, and a progress management program.

### BACKGROUND ART

There is a technology for managing progress of work in a project such as system development.

Patent Literature 1 discloses a work management device that manages work of a person in charge who is responsible for performing tasks related to a project. The work management device determines whether there is a delayed task whose progress is delayed with regard to assigned tasks based on person-in-charge related information, and if there is a delayed task, notifies the person in charge of the task that a delay has occurred.

### CITATION LIST

### Patent Literature

Patent Literature 1: JP 2019-091213 A

### SUMMARY OF INVENTION

### Technical Problem

In a project such as system development, each person in charge needs to manage progress of a task for which each person in charge is responsible and frequently share the progress with other persons in charge. Each person in charge shares information by revealing a plan (such as an implementation period) and an implementation status (such as a progress rate) of the task for which each person in charge is responsible. Each person in charge needs to estimate a possibility of occurrence of a delay in each task, a scale of the delay, and so on based on progress of tasks that affect each person in charge, and promptly deal with the estimated delay.

When the frequency of updates of progress corresponding to an ongoing task is relatively low, it is considered that there is a delay risk in the ongoing task. However, a problem of the technology disclosed in Patent Literature 1 is that when the frequency of updates of progress corresponding to an ongoing task is relatively low, a delay risk in the ongoing task is not detected.

An object of the present disclosure is, in a technology for managing progress of system development, to detect a delay risk in an ongoing task when the frequency of updates of progress corresponding to the ongoing task is relatively low.

### Solution to Problem

A progress management device according to the present disclosure manages progress of system development based on progress that corresponds to each task in the system development and is input by a person in charge of each task, and the progress management device includes

a delay risk calculation unit to determine whether there is a risk of occurrence of a delay in an ongoing task, which is a task in progress in the system development, based on the number of times a target person in charge, who is a person in charge of the ongoing task, has input progress corresponding to the ongoing task.

### Advantageous Effects of Invention

According to the present disclosure, a delay risk calculation unit determines whether there is a risk of occurrence of a delay in an ongoing task based on the number of times a target person in charge has input progress corresponding to the ongoing task. Therefore, according to the present disclosure, in a technology for managing progress of system development, it is possible to detect a delay risk in an ongoing task when the frequency of updates of progress corresponding to the ongoing task is relatively low.

### BRIEF DESCRIPTION OF DRAWINGS

FIG. 1 is a diagram illustrating an example of the configuration of a progress management system 90 according to Embodiment 1.

FIG. 2 is a diagram describing the operation of the progress management system 90 according to Embodiment 1.

FIG. 3 is a diagram illustrating an example of the configuration of each device included in the progress management system 90 according to Embodiment 1.

FIG. 4 is a flowchart illustrating the operation of a progress input flow according to Embodiment 1.

FIG. 5 is a flowchart illustrating an input record calculation flow for an ongoing task according to Embodiment 1.

FIG. 6 is a diagram describing the input record calculation flow according to Embodiment 1.

FIG. 7 is a diagram illustrating an example of the hardware configuration of a progress management device 100 according to a variation of Embodiment 1.

FIG. 8 is a flowchart illustrating an input record calculation flow for a completed task according to Embodiment 2.

FIG. 9 is a flowchart illustrating an input record calculation flow for an ongoing task according to Embodiment 2.

FIG. 10 is a diagram describing the input record calculation flow according to Embodiment 2.

### DESCRIPTION OF EMBODIMENTS

In the description and drawings of the embodiments, the same reference numerals are assigned to the same elements and corresponding elements. Description of elements with the same reference numerals is omitted or simplified as appropriate. Arrows in diagrams mainly indicate flows of data or flows of processing. “Unit” may be interpreted as “circuit”, “step”, “procedure”, “process”, or “circuitry” as appropriate.

### Embodiment 1

This embodiment will be described in detail below with reference to the drawings.

### Description of Configuration

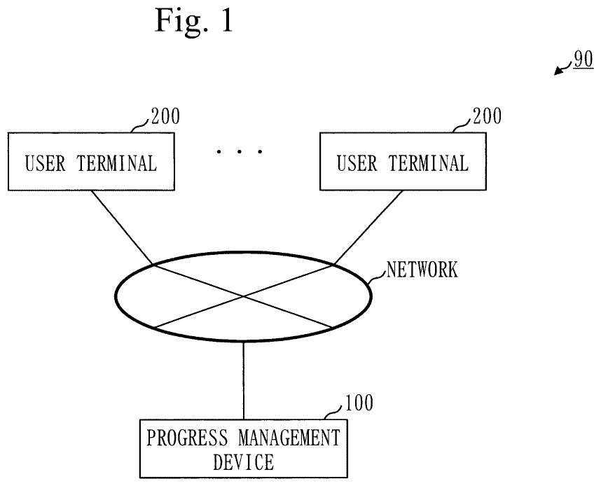

FIG. 1 illustrates an example of the configuration of a progress management system 90 according to this embodiment. As illustrated in FIG. 1, the progress management system 90 includes a progress management device 100 and a plurality of user terminals 200. The progress management device 100 and each user terminal 200 are connected so as to be able to communicate with each other via a network. The progress management device 100 and the user terminal 200 may be configured integrally as appropriate.

As a specific example, the progress management system 90 is a system that has a function of allocating necessary resources (such as work personnel and computing resources) to each test in a testing process of system development, and manages and shares influences of delays and so on based on relationships between tests. The system to be developed is a system that includes software.

In the progress management system 90, each person in charge of a plurality of persons in charge inputs and manages information on a task (such as an implementation period and progress) for which each person in charge is responsible. As a specific example, a task refers to each test item in the testing process.

In the progress management system 90, each person in charge can check, before the start of the test of each person in charge, the implementation status of other tasks that may affect the start of the task for which each person in charge is responsible. In addition, during the implementation of the test of each person in charge, each person in charge can check the influence that the implementation status of the task for which each person in charge is responsible has on tasks of other persons in charge.

The progress management device 100 detects a delay risk in each task based on input records (frequency) of progress corresponding to each task. A delay risk in a task is a risk of occurrence of a delay in the task. If a task has a delay risk, there is a possibility that the task may not be completed as planned. The progress management device 100 manages progress of the system development based on progress that corresponds to each task in the system development and is input by the person in charge of each task.

The user terminal 200 is a terminal for each person in charge to input progress corresponding to each task for which each person in charge is responsible and to check progress corresponding to each task. The user terminal 200 is, as a specific example, a personal computer (PC) or a tablet terminal.

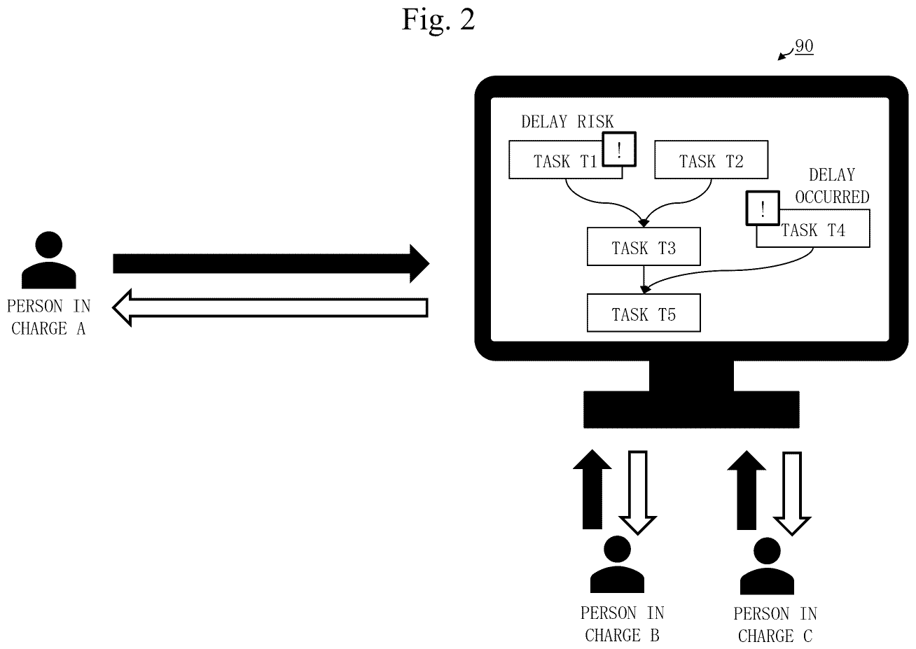

FIG. 2 is a diagram describing a specific example of the operation of the progress management system 90. This example will be described below. In the progress management system 90, in order to smoothly advance the testing process, each person in charge inputs information related to a test, and shares results of collating input information.

First, each person in charge inputs information on the test for which each person in charge is responsible into each user terminal 200. The information on the test is, as a specific example, information indicating an implementation schedule, progress, and a delay or delay risk. Each user terminal 200 transmits the input information to the progress management device 100.

Next, the progress management device 100 receives the information from each user terminal 200, analyzes the received information, and transmits information indicating the result of analysis to each user terminal 200.

Next, each user terminal 200 receives the information from the progress management device 100, and displays the received information on a screen of each user terminal 200. In this example, each user terminal 200 displays a relationship between tasks using a directed graph. In this case, each user terminal 200 displays that there is a delay risk in a task T1 and that a delay has occurred in a task T4.

Next, based on the information displayed on each user terminal 200, each person in charge considers the need for plan modifications and so on in response to the delay and the delay risk.

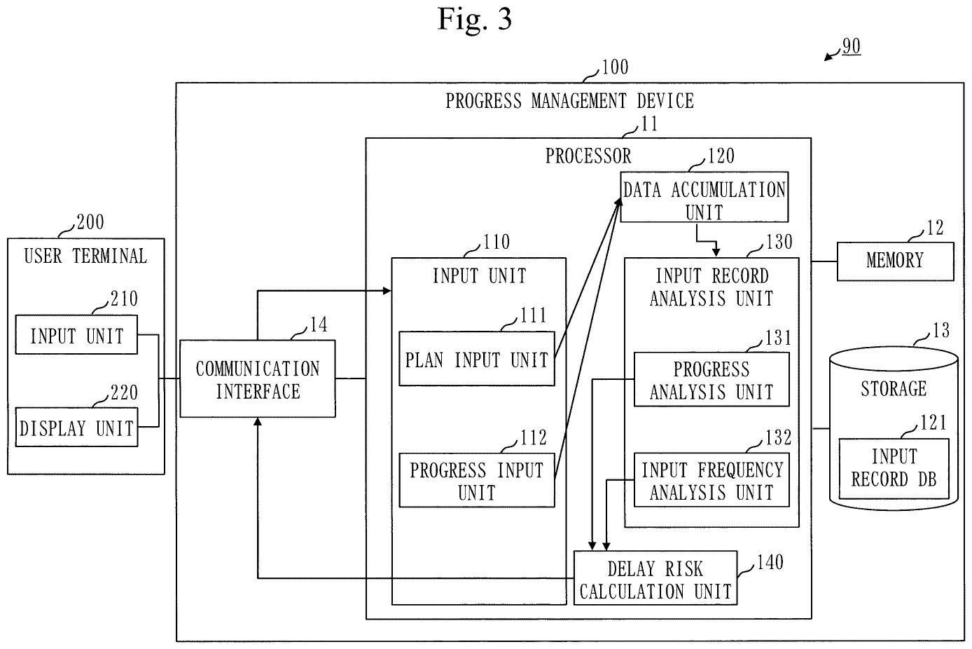

FIG. 3 illustrates an example of the configuration of each device included in the progress management system 90.

As illustrated in FIG. 3, the progress management device 100 includes, as functional components, an input unit 110, a data accumulation unit 120, an input record analysis unit 130, and a delay risk calculation unit 140.

The user terminal 200 includes an input unit 210 and a display unit 220.

The input unit 110 includes a plan input unit 111 and a progress input unit 112.

The plan input unit 111 accepts information indicating a plan for executing each task.

The progress input unit 112 accepts information indicating progress corresponding to each task.

The data accumulation unit 120 appropriately stores information received by each of the plan input unit 111 and the progress input unit 112 in a storage 13. The data accumulation unit 120 also stores data indicating input records of progress corresponding to each task in an input record database (DB) 121.

As a specific example, the input record DB 121 retains the number of progress inputs corresponding to each task as data related to the implementation status of each task. The input record DB 121 may also retain information indicating a period in which there is no progress input operation corresponding to each task analyzed by the data accumulation unit 120 as data related to the implementation status of each task. As a specific example, the data held by the input record DB 121 is used for calculation of a delay risk and so on. As a specific example, the input record DB 121 is realized by the storage 13.

The input record analysis unit 130 includes a progress analysis unit 131 and an input frequency analysis unit 132.

The progress analysis unit 131 refers to the plan and progress corresponding to each task, and analyzes a difference between the plan and progress corresponding to each task.

The input frequency analysis unit 132 analyzes a frequency of progress inputs corresponding to each task. The input frequency analysis unit 132 may analyze a period in which there is no progress input operation corresponding to each task.

The delay risk calculation unit 140 determines whether there is a risk of occurrence of a delay in an ongoing task based on the number of times a target person in charge, who is a person in charge of the ongoing task, has input progress corresponding to the ongoing task. The ongoing task is a task in the system development that is not completed and is in progress. As a specific example, the delay risk calculation unit 140 calculates a delay risk in each task based on results of analysis by the progress analysis unit 131 and the input frequency analysis unit 132, and transmits data indicating the calculated delay risk to each user terminal 200.

The delay risk calculation unit 140 may determine that there is a risk of occurrence of a delay in the ongoing task if a rate of the cumulative number of days on which the target person in charge has input progress corresponding to the ongoing task in relation to the cumulative number of days on which the target person in charge has executed the ongoing task is less than or equal to a delay standard rate. The delay standard rate may be set in any way. The delay risk calculation unit 140 may detect a delay risk based on the total number of progress inputs, a pace of progress inputs, a ratio of a period in which progress has been input to a period in which no progress has been input, and so on. The delay risk calculation unit 140 may determine that there is a delay risk if no progress input operation is performed for a fixed period.

The input unit 210 accepts progress inputs corresponding to each task from the person in charge.

The display unit 220 displays data received from the progress management device 100.

As illustrated in FIG. 3, the progress management device 100 is a computer that includes hardware such as a processor 11, a memory 12, the storage 13, and a communication interface 14. These hardware components are appropriately connected via signal lines. The progress management device 100 may be composed of a plurality of computers.

The processor 11 is an integrated circuit (IC) that performs operational processing and controls the hardware included in the computer. The processor 11 is, as a specific example, a central processing unit (CPU), a digital signal processor (DSP), or a graphics processing unit (GPU).

The progress management device 100 may include a plurality of processors as an alternative to the processor 11. The plurality of processors share the role of the processor 11.

The memory 12 is typically a volatile storage device and is, as a specific example, a random access memory (RAM). The memory 12 is also called a main storage device or a main memory. The data saved in the memory 12 is stored in the storage 13 as needed.

The storage 13 is typically a non-volatile storage device and is, as a specific example, a read only memory (ROM), a hard disk drive (HDD), or a flash memory. The data stored in the storage 13 is loaded into the memory 12 as needed.

The memory 12 and the storage 13 may be configured integrally.

The communication interface 14 is a receiver and a transmitter. The communication interface 14 is, as a specific example, a communication chip or a network interface card (NIC).

The storage 13 stores a progress management program. The progress management program is a program that causes a computer to realize the functions of each unit included in the progress management device 100. The progress management program is loaded into the memory 12 and executed by the processor 11. The functions of each unit included in the progress management device 100 are realized by software.

Data used when the progress management program is executed, data obtained by executing the progress management program, and so on are appropriately stored in a storage device. Each unit of the progress management device 100 appropriately uses the storage device. As a specific example, the storage device is composed of at least one of the memory 12, the storage 13, registers in the processor 11, and a cache memory in the processor 11. The term data and the term information may have equivalent meanings. The storage device may be independent of the computer.

The functions of the memory 12 and the storage 13 may be realized by other storage devices.

The progress management program may be recorded in a computer readable non-volatile recording medium. As a specific example, the non-volatile recording medium is an optical disc or a flash memory. The progress management program may be provided as a program product.

The hardware configuration of the user terminal 200 may be substantially the same as the hardware configuration of the progress management device 100.

### Description of Operation

A procedure for the operation of the progress management device 100 is equivalent to a progress management method. A program that realizes the operation of the progress management device 100 is equivalent to the progress management program.

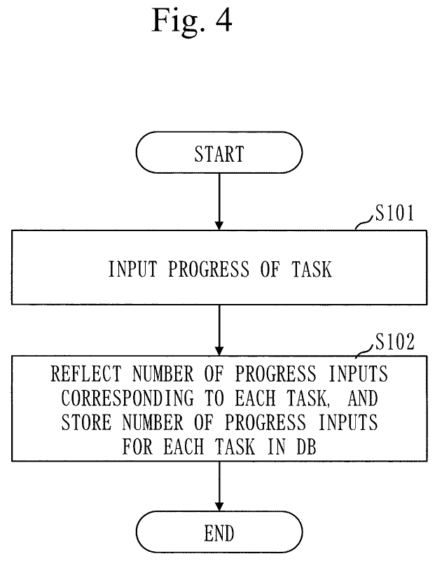

FIG. 4 is a flowchart illustrating an example of a progress input flow. Using FIG. 4, the progress input flow will be described.

### (Step S101)

Each person in charge inputs progress corresponding to a task for which each person in charge is responsible into the user terminal 200. At this time, each person in charge may input a progress rate of each task, or select a test item that has been executed and completed from a list indicating test items corresponding to each task.

The input unit 210 transmits information indicating the input progress to the progress management device 100.

### (Step S102)

The data accumulation unit 120 counts the number of progress inputs corresponding to each task based on a progress input record corresponding to each task, and stores data indicating the counted number of inputs in the input record DB 121.

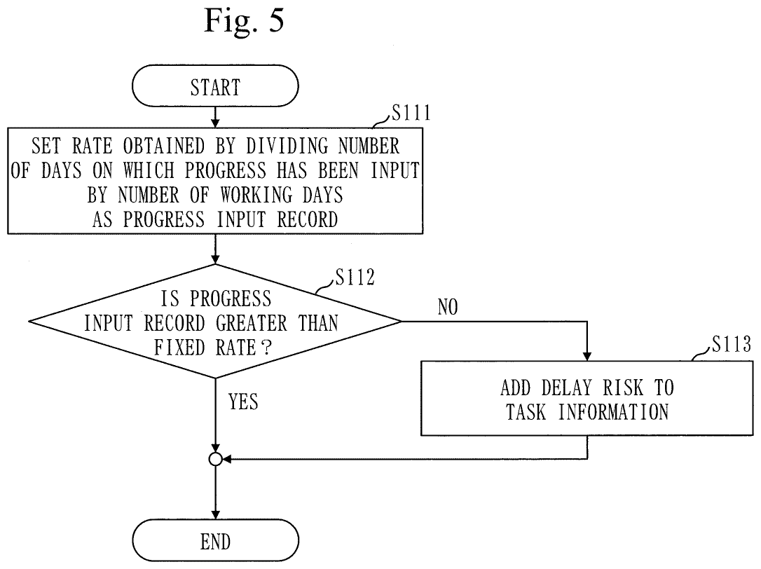

FIG. 5 is a flowchart illustrating an example of an input record calculation flow for an ongoing task. Using FIG. 5, the input record calculation flow will be described. In the following, an ongoing task is each task that is in progress and corresponds to data stored in the input record DB 121.

### (Step S111)

The input frequency analysis unit 132 calculates, as a progress input record, a rate obtained by dividing the number of days on which progress corresponding to an ongoing task is input by the number of working days.

### (Step S112)

If the progress input record calculated in step S111 is greater than a fixed rate, the progress management device 100 ends the processing of this flowchart. Otherwise, the progress management device 100 proceeds to step S113.

### (Step S113)

The delay risk calculation unit 140 adds information indicating a delay risk to information indicating the ongoing task, and transmits the information indicating the ongoing task to which the information indicating the delay risk has been added to the user terminal 200.

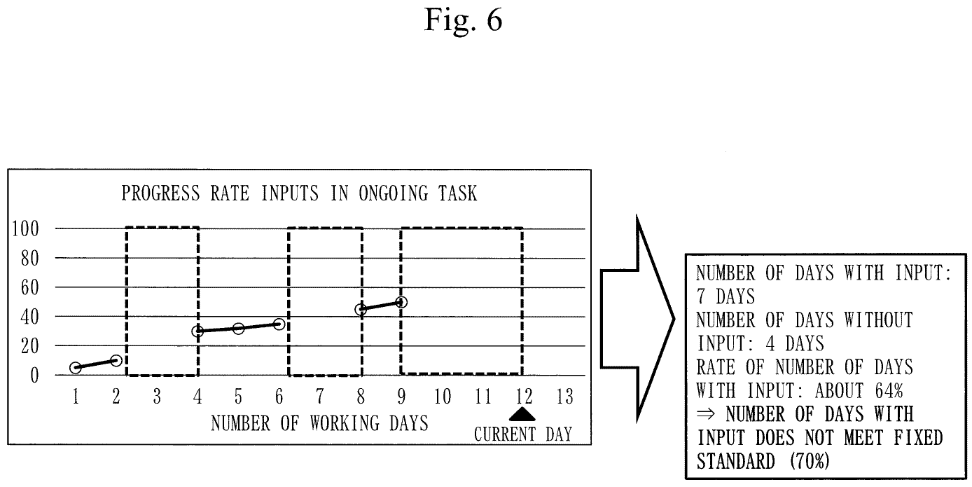

FIG. 6 illustrates a specific example of the input record calculation flow.

The delay risk calculation unit 140 determines that there is a delay risk in the ongoing task if the frequency of progress rate inputs corresponding to the ongoing task does not meet a fixed standard. The rate of the number of days on which progress rate inputs are performed corresponds to the frequency of inputs, and the fixed standard is 70%. It is also assumed that the person in charge of the ongoing task is to input a progress rate corresponding to the ongoing task once a day. If the person in charge inputs progress rates multiple times on a certain day, the number of progress rate inputs on that day may be regarded as one.

In this example, it is assumed that it is currently the 12th day since the start of the ongoing task, and progress rates corresponding to the ongoing task have been input for a total of 7 days out of a total of 11 past working days. Therefore, the rate of input days is about 64%, which does not meet the fixed standard. Accordingly, the delay risk calculation unit 140 determines that there is a delay risk in the ongoing task. If the progress inputs corresponding to the ongoing task do not meet the fixed standard, it is considered that there is a possibility that a failure causing a delay may have occurred in the ongoing task.

In FIG. 6, the number of times progress rates are input is seven times. The delay risk calculation unit 140 may determine whether there is a delay risk solely based on the number of times progress rates are input, which is seven times.

### Description of Effects of Embodiment 1

According to this embodiment, when progress corresponding to a task for which a person in charge is responsible has not been input, a delay risk in the task is detected based on the frequency of progress inputs corresponding to the task. Therefore, according to this embodiment, each person in charge can be aware of a delay risk for a task for which each person in charge is responsible even when the frequency of progress inputs by other persons in charge is low.

### Other Configurations

### <Variation 1>

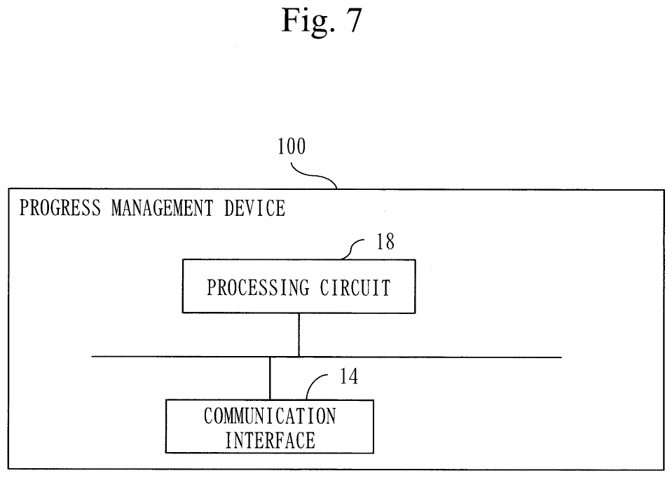

FIG. 7 illustrates an example of the hardware configuration of the progress management device 100 according to this variation.

The progress management device 100 includes a processing circuit 18 in place of the processor 11, in place of the processor 11 and the memory 12, in place of the processor 11 and the storage 13, or in place of the processor 11, the memory 12, and the storage 13.

The processing circuit 18 is hardware that realizes at least part of the units included in the progress management device 100.

The processing circuit 18 may be dedicated hardware, or may be a processor that executes programs stored in the memory 12.

When the processing circuit 18 is dedicated hardware, the processing circuit 18 is, as a specific example, a single circuit, a composite circuit, a programmed processor, parallel-programmed processors, an application specific integrated circuit (ASIC), a field programmable gate array (FPGA), or a combination of these.

The progress management device 100 may include a plurality of processing circuits as an alternative to the processing circuit 18. The plurality of processing circuits share the role of the processing circuit 18.

In the progress management device 100, some functions may be realized by dedicated hardware, and the remaining functions may be realized by software or firmware.

As a specific example, the processing circuit 18 is realized by hardware, software, firmware, or a combination of these.

The processor 11, the memory 12, the storage 13, and the processing circuit 18 are collectively referred to as “processing circuitry”. That is, the functions of the functional components of the progress management device 100 are realized by the processing circuitry.

The progress management device 100 according to other embodiments may have substantially the same configuration as that of this variation.

### Embodiment 2

Differences from the embodiment described above will be mainly described below with reference to the drawings.

### Description of Configuration

The configuration of the progress management system 90 according to this embodiment is substantially the same as the configuration of the progress management system 90 according to Embodiment 1.

The input frequency analysis unit 132 according to this embodiment analyzes a tendency of progress inputs by each person in charge based on a progress input record of each person in charge in a task completed by each person in charge. As a specific example, the tendency of progress inputs is the frequency of progress inputs, a time period in which progress inputs are performed, or the maximum value of an interval between two consecutive progress inputs.

The delay risk calculation unit 140 according to this embodiment determines whether there is a risk of occurrence of a delay in an ongoing task based on a comparison between the tendency of progress inputs by the target person in charge in a task executed and completed by the target person in charge in the past in system development with the tendency of progress inputs by the target person in charge in the ongoing task. The tendency of inputs is, as a specific example, the frequency of inputs. As a specific example, the delay risk calculation unit 140 determines that there is a delay risk in the ongoing task for which each person in charge is responsible if the tendency of progress inputs corresponding to the ongoing task by each person in charge is inferior to a certain degree or more to the tendency of previous progress inputs by each person in charge.

### Description of Operation

The progress input flow according to this embodiment is substantially the same as the progress input flow according to Embodiment 1. Differences from Embodiment 1 will be described below.

### (Step S102)

The data accumulation unit 120 appropriately stores information to be used by the input frequency analysis unit 132, such as a date and time when progress is input, in the input record DB 121 in addition to the number of inputs.

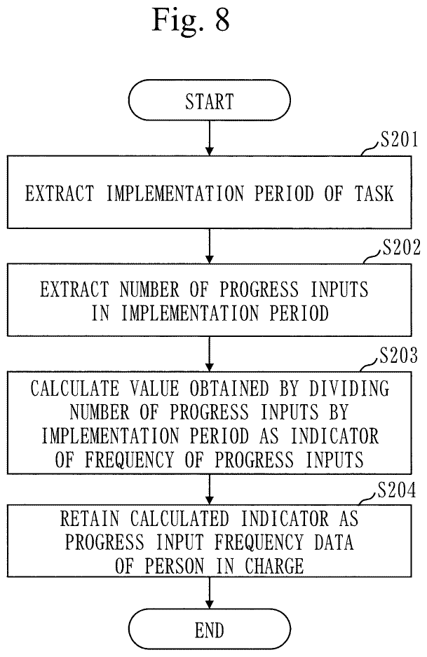

FIG. 8 is a flowchart illustrating an example of an input frequency calculation flow for a completed task. Using FIG. 8, the input frequency calculation flow will be described. A completed task is each task that has been executed and completed and corresponds to data stored in the input record DB 121.

### (Step S201)

The input frequency analysis unit 132 extracts an implementation period of a completed task. The implementation period is, as a specific example, the number of working days.

### (Step S202)

The input frequency analysis unit 132 extracts the number of progress inputs corresponding to the completed task in the implementation period.

### (Step S203)

The input frequency analysis unit 132 calculates, as an indicator of the frequency of progress inputs, a value obtained by dividing the number of progress inputs extracted in step S202 by a value corresponding to the implementation period. The indicator of the frequency of progress inputs may be a value obtained by dividing the value corresponding to the implementation period by the number of progress inputs, or may be a value calculated in any other way based on the number of progress inputs and the value corresponding to the implementation period.

### (Step S204)

The input frequency analysis unit 132 retains the indicator calculated in step S203 as progress input frequency data corresponding to the person in charge who has executed the completed task. Progress input frequency data corresponding to a person in charge indicates the frequency of progress inputs in tasks executed and completed by the person in charge in the past. As a specific example, the frequency of progress inputs is the average value of frequencies of progress inputs in all or part of tasks executed and completed by the person in charge in the past.

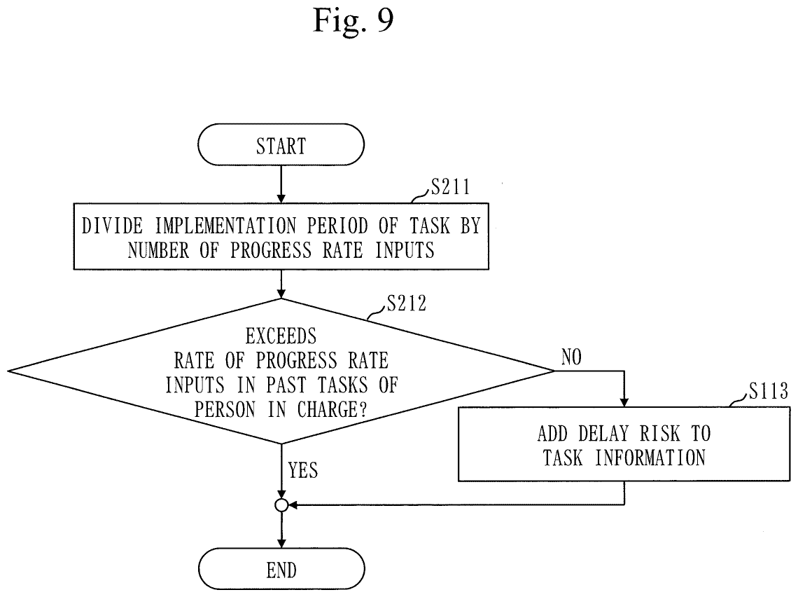

FIG. 9 is a flowchart illustrating an example of an input frequency calculation flow for an ongoing task according to this embodiment. Using FIG. 9, the input frequency calculation flow will be described.

### (Step S211)

The input frequency analysis unit 132 calculates a value obtained by dividing the number of progress rate inputs corresponding to an ongoing task by a value corresponding to an implementation period corresponding to the ongoing task. The implementation period corresponding to the ongoing task is, as a specific example, the cumulative number of days on which the ongoing task is implemented.

### (Step S212)

If the value calculated in step S211 exceeds the frequency of progress rate inputs indicated by the progress input frequency data corresponding to the person in charge who is executing the ongoing task, the progress management device 100 ends the processing of this flowchart. Otherwise, the progress management device 100 proceeds to step S113.

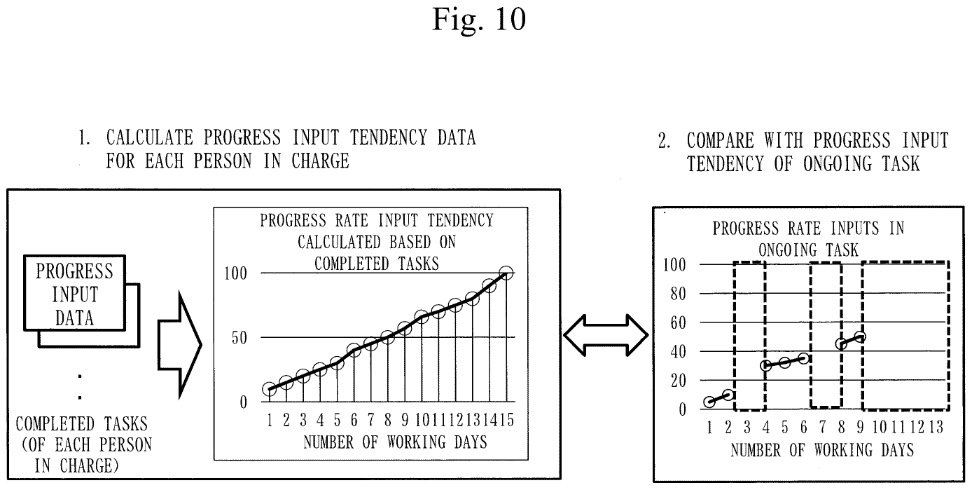

FIG. 10 is a diagram describing the input frequency calculation flow. In FIG. 10, the tendency of progress rate inputs corresponding to completed tasks is shown on the left side, and the tendency of progress rate inputs corresponding to the ongoing task is shown on the right side. Based on these tendencies of inputs, the input frequency analysis unit 132 determines whether the frequency of progress rate inputs corresponding to the ongoing task is lower to a certain degree or more than the frequency of progress rate inputs corresponding to the completed task. The delay risk calculation unit 140 determines whether there is a delay risk for the ongoing task according to the result of determination by the input frequency analysis unit 132.

As a specific example, a case will be considered where a person in charge A is implementing a task T4 after completing a task T1 to a task T3. That is, a case will be considered where the task T1 to the task T3 are completed tasks and the task T4 is an ongoing task. In this case, as a specific example, if the number of progress inputs is once a day in the task T1 to the task T3, but the number of progress inputs is once in every two days in the task T4, the input frequency analysis unit 132 determines that the frequency of progress inputs corresponding to the task T4 is lower to a certain degree or more. As a result, the delay risk calculation unit 140 determines that there is a delay risk in the task T4. If the frequency of progress inputs corresponding to the ongoing task is lower than the frequency of previous inputs by the person in charge of the ongoing task, it is considered that there is a possibility that an obstacle causing a delay may have occurred in the ongoing task.

### Description of Effects of Embodiment 2

According to this embodiment, it is possible to determine whether there is a delay risk in an ongoing task for which each person in charge is responsible based on the tendency of progress inputs by each person in charge in the past.

### Other Embodiments

The embodiments described above can be freely combined, or any component of each embodiment can be modified. Alternatively, any component in each embodiment can be omitted.

The embodiments are not limited to those indicated in Embodiments 1 and 2, and various changes can be made as necessary. The procedures described using flowcharts or the like may be appropriately changed.

### REFERENCE SIGNS LIST

11: processor; 12: memory; 13: storage; 14: communication interface; 18: processing circuit; 90: progress management system; 100: progress management device; 110: input unit; 111: plan input unit; 112: progress input unit; 120: data accumulation unit; 121: input record DB; 130: input record analysis unit; 131: progress analysis unit; 132: input frequency analysis unit; 140: delay risk calculation unit; 200: user terminal; 210: input unit; 220: display unit.

1. A progress management device to manage progress of system development based on progress that corresponds to each task in the system development and is input by a person in charge of each task, the progress management device comprising
processing circuitry to determine whether there is a risk of occurrence of a delay in an ongoing task, which is a task in progress in the system development, based on the number of times a target person in charge, who is a person in charge of the ongoing task, has input progress corresponding to the ongoing task.

2. The progress management device according to claim 1,
wherein the processing circuitry determines that there is a risk of occurrence of a delay in the ongoing task when a rate of a cumulative number of days on which the target person in charge has input progress corresponding to the ongoing task in relation to a cumulative number of days on which the target person in charge has executed the ongoing task is less than or equal to a delay standard rate.

3. The progress management device according to claim 1,
wherein the processing circuitry determines whether there is a risk of occurrence of a delay in the ongoing task based on a comparison between a tendency of inputs of progress by the target person in charge in a task executed and completed previously by the target person in charge in the system development and a tendency of inputs of progress by the target person in charge in the ongoing task.

4. The progress management device according to claim 2,
wherein the processing circuitry determines whether there is a risk of occurrence of a delay in the ongoing task based on a comparison between a tendency of inputs of progress by the target person in charge in a task executed and completed previously by the target person in charge in the system development and a tendency of inputs of progress by the target person in charge in the ongoing task.

5. The progress management device according to claim 3, wherein the tendency of inputs is a frequency of inputs.

6. The progress management device according to claim 4, wherein the tendency of inputs is a frequency of inputs.

7. A progress management method that is executed by a progress management device, which is a computer, to manage progress of system development based on progress that corresponds to each task in the system development and is input by a person in charge of each task, the progress management method comprising
determining whether there is a risk of occurrence of a delay in an ongoing task, which is a task in progress in the system development, based on the number of times a target person in charge, who is a person in charge of the ongoing task, has input progress corresponding to the ongoing task, by the progress management device.

8. A non-transitory computer readable medium storing a progress management program that is executed by a progress management device, which is a computer, to manage progress of system development based on progress that corresponds to each task in the system development and is input by a person in charge of each task, the progress management program causing the progress management device to execute
a delay risk calculation process of determining whether there is a risk of occurrence of a delay in an ongoing task, which is a task in progress in the system development, based on the number of times a target person in charge, who is a person in charge of the ongoing task, has input progress corresponding to the ongoing task.
